(19) United States
(12) Patent Application Publication
(10) Pub. No.: US 2025/0182441 A1
(43) Pub. Date: Jun. 5, 2025

(54) MODEL GENERATION DEVICE, MODEL GENERATION METHOD, AND PROGRAM

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 18/947,083

(22) Filed: Nov. 14, 2024

(30) Foreign Application Priority Data
Dec. 5, 2023 (JP) 2023-205005

(51) Int. Cl. G06V 10/70; G06T 7/70; G06V 20/40

(52) U.S. Cl. CPC G06V 10/70; G06T 7/70; G06V 20/41; G06T 2207/10016

(57) ABSTRACT

A model generation device of the present disclosure includes a recognition unit that generates, from measurement data including a plurality of frames obtained by measuring a space by a sensor, object recognition information representing information of an object recognized for each of the frames; a prediction information generation unit that generates, for each of the frames, prediction information in which situation information representing the situation at the time of measuring the space is added to the object recognition information; and a model generation unit that generates a model that inputs thereto a plurality of units of the prediction information corresponding to the plurality of frames and outputs an object recognition result in the space, by machine learning using the input units of prediction information, the output object recognition result, and correct data of the object recognition result.

### INCORPORATION BY REFERENCE

The present invention is based upon and claims the benefit of priority from Japanese patent application No. 2023-205005, filed on Dec. 5, 2023, the disclosure of which is incorporated herein in its entirety by reference.

### TECHNICAL FIELD

The present disclosure relates to a model generation device, a model generation method, and a program.

### BACKGROUND ART

Recognition of an object using measurement data obtained by measuring the inside of a space has been performed, as described in Patent Literature 1. Specifically, Patent Literature 1 describes recognizing the position of a luggage by using distance data obtained by measuring the inside of a warehouse.
Patent Literature 1: JP 2010-23950 A

### SUMMARY

However, in the art as described in Patent Literature 1, there is a case where point cloud data that is measurement data is sparse, which causes a problem that the recognition accuracy of an object is lowered.

In view of the above, an exemplary object of the present disclosure is to solve the above-described problem, that is, in the case of recognizing an object from measurement data obtained by measuring a space, the recognition accuracy is lowered.

A model generation device, according to one aspect of the present disclosure, is configured to include
a recognition unit that generates, from measurement data including a plurality of frames obtained by measuring a space by a sensor, object recognition information representing information of an object recognized for each of the frames,
a prediction information generation unit that generates, for each of the frames, prediction information in which situation information representing the situation at the time of measuring the space is added to the object recognition information, and
a model generation unit that generates a model that inputs thereto a plurality of units of the prediction information corresponding to the plurality of frames and outputs an object recognition result in the space, by machine learning using the input units of prediction information, the output object recognition result, and correct data of the object recognition result.

Further, a model generation method according to one aspect of the present disclosure is configured to include
generating, from measurement data including a plurality of frames obtained by measuring a space by a sensor, object recognition information representing information of an object recognized for each of the frames,
for each of the frames, generating prediction information in which situation information representing the situation at the time of measuring the space is added to the object recognition information, and
generating a model that inputs thereto a plurality of units of the prediction information corresponding to the plurality of frames and outputs an object recognition result in the space, by machine learning using the input units of prediction information, the output object recognition result, and correct data of the object recognition result.

Further, a program according to one aspect of the present disclosure is configured to cause a computer to execute processing to
generate, from measurement data including a plurality of frames obtained by measuring a space by a sensor, object recognition information representing information of an object recognized for each of the frames,
for each of the frames, generate prediction information in which situation information representing the situation at the time of measuring the space is added to the object recognition information, and
generate a model that inputs thereto a plurality of units of the prediction information corresponding to the plurality of frames and outputs an object recognition result in the space, by machine learning using the input units of prediction information, the output object recognition result, and correct data of the object recognition result.

With the configurations described above, the present disclosure is able to improve the recognition accuracy in the case of recognizing an object from measurement data obtained by measuring a space.

### BRIEF DESCRIPTION OF DRAWINGS

FIG. 1 is a block diagram illustrating a configuration of a model generation device according to the present disclosure;

FIG. 2 illustrates a state of processing by the model generation device according to the present disclosure;

FIG. 3 illustrates a state of processing by the model generation device according to the present disclosure;

FIG. 4 illustrates a state of processing by the model generation device according to the present disclosure;

FIG. 5 illustrates a state of processing by the model generation device according to the present disclosure;

FIG. 6 illustrates a state of processing by the model generation device according to the present disclosure;

FIG. 7 illustrates a state of processing by the model generation device according to the present disclosure;

FIG. 8 is a flowchart illustrating a processing operation by the model generation device according to the present disclosure;

FIG. 9 is a block diagram illustrating a hardware configuration of a model generation device according to the present disclosure; and

FIG. 10 is a block diagram illustrating a configuration of the model generation device according to the present disclosure.

### EXEMPLARY EMBODIMENTS

### First Example Embodiment

A first example embodiment of the present disclosure will be described with reference to the drawings. Note that the drawings may be related to any example embodiments.

### [Configuration]

A model generation device 10 of the present embodiment is a device that generates a model that recognizes an object from measurement data obtained by measuring the inside of a space. As an example, the present embodiment describes generation of a model that recognizes a luggage, heavy equipment, a person, or the like that is an object, from measurement data obtained by measuring the space in a warehouse. However, an object to be recognized may be any object without being limited to a luggage or the like in a warehouse, and the space may be any place without being limited to the inside of a warehouse.

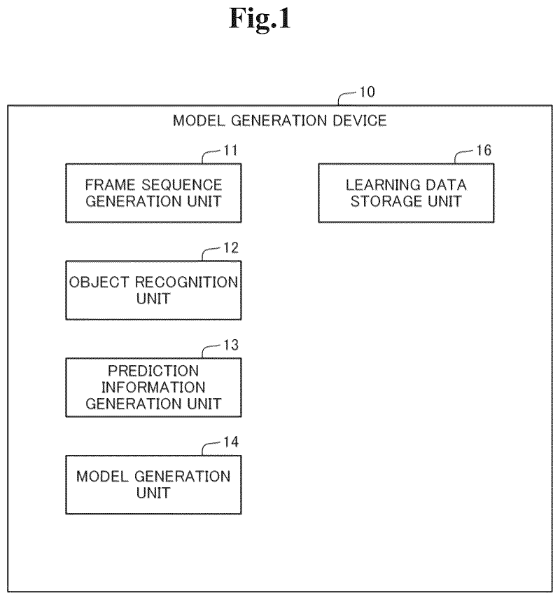

The model generation device 10 is configured of one or a plurality of information processing devices each having an arithmetic device and a storage device. As illustrated in FIG. 1, the model generation device 10 includes a frame sequence generation unit 11, an object recognition unit 12, a prediction information generation unit 13, and a model generation unit 14. The functions of the frame sequence generation unit 11, the object recognition unit 12, the prediction information generation unit 13, and the model generation unit 14 can be realized through execution, by the arithmetic device, of a program for implementing the respective functions stored in the storage device. The model generation device 10 also includes a learning data storage unit 16 configured of a storage device. Hereinafter, the respective constituent elements will be described in detail.

The learning data storage unit 16 stores therein learning data used for generating the model. The learning data is configured of measurement data obtained by measuring the inside of a warehouse, and correct data that is information of an object existing in the warehouse. The measurement data is measurement data obtained by measuring the inside of the warehouse with a sensor. In particular, in the present embodiment, the measurement data is assumed to be distance data consisting of point cloud data representing the distance up to an object at each position measured by three-dimensional light detection and ranging (LiDAR). However, the measurement data is not limited to distance data consisting of distance images measured by the three-dimensional LiDAR, and may be distance data measured with any sensor.

The measurement data that is learning data is configured to include a plurality of frames each obtained by measuring the same location at the same time. That is, the measurement data is configured of a plurality of frames F acquired by measuring the same location a plurality of times in time series. For example, the measurement data consists of a plurality of frames acquired at intervals of ten frames or five frames per second.

The correct data that is learning data is configured of information specifying an object actually existing in the warehouse, that is, an object that is present in the measurement data. For example, the correct data is configured of vector information, including information about presence/absence of an object, the type of an object, the position of an object, the size of an object, and the posture of ah object. As an example, presence/absence (obj) of an object is shown as “1 (presence), 0 (absence)”, and the type (cls) of an object is shown as “luggage, heavy equipment, person” or the like. The position (x, y, z) of an object is shown as three-dimensional coordinate values at which the reference part of an object is positioned in the space in the warehouse, and the size (dx, dy, dz) of an object is shown as a three-dimensional length representing the size of the object. The posture (θ) of an object is shown as an inclination of the object with respect to the reference direction. As described above, the correct data includes presence/absence of an object and information about a rectangle (rectangular parallelepiped shape) specified by the position, size, and posture of the object. However, the correct data is not limited to including the above-described information. The correct data may be a part thereof, or may include other types of information.

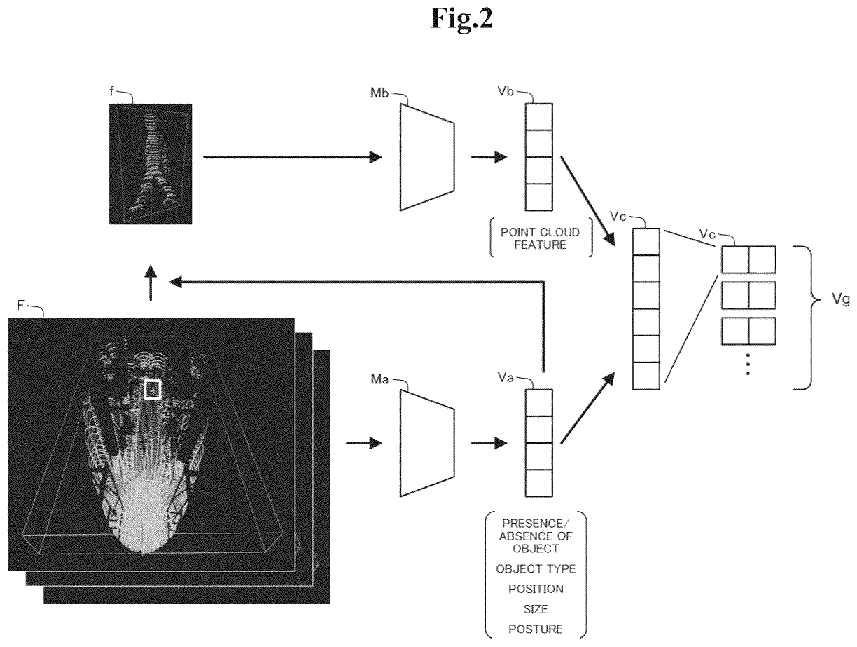

The frame sequence generation unit 11 extracts measurement data configured of a plurality of frames F obtained by measuring the same location from the learning data, and generates it as a learning object. For example, the frame sequence generation unit 11 extracts measurement data configured of ten frames obtained by measuring the same location one second. FIG. 2 illustrates an example of the frame F of the measurement data. The frame sequence generation unit 11 is not limited to extracting and generating measurement data of the aforementioned number of frames as a learning object, and may extract any number of frames. Moreover, the frame sequence generation unit 11 is not limited to extracting a plurality of continuous frames, and may extract a plurality of thinned out frames.

The object recognition unit 12 (recognition unit) performs processing to recognize an object from the plurality of frames F generated as a learning object as described above, and generates object recognition information. At this time, the object recognition unit 12 generates object recognition information representing the result of recognizing an object for each frame F. In the present embodiment, the object recognition unit 12 inputs, to an object recognition model Ma having performed machine learning, distance data that is point cloud data consisting of one frame F, and acquires an object prediction vector Va output from the object recognition model Ma, to thereby generate object recognition information for each frame F. Here, the object prediction vector Va that is object recognition information is configured of presence/absence of an object, the type of the object, the position of the object, the size of the object, and the posture of the object, as similar to the correct data for example. As described above, the object prediction vector Va includes presence/absence of an object and information about a rectangle (rectangular parallelepiped shape) specified by the position, size, and posture of the object. The object recognition unit 12 is not limited to generating the entire object recognition information described above, and may be a part thereof or may generate object recognition information including other types of information.

The object recognition model Ma is generated by machine-learning the learning data configured of a set of distance data that is point cloud data consisting of prepared frames and an object prediction vector that is object recognition information of the object that is present in the frame. However, the object recognition unit 12 is not limited to generating the object prediction vector Va that is object recognition information by using the object recognition model Ma. The object recognition unit may generate the object prediction vector Va that is object recognition information by a method of performing arithmetic processing for object recognition prepared in advance using the distance data in the frame.

The prediction information generation unit 13 generates a prediction profile (prediction information) in which environment information (situation information) representing the situation at the time of measuring the measured space to the object recognition information. At that time, the prediction information generation unit 13 generates a prediction profile for each frame F, as similar to the object recognition unit 12 described above. Specifically, in the present embodiment, the prediction information generation unit 13 generates, from distance data that is point cloud data consisting of the frame F, a feature vector Vb configured of a feature value of the distance data, as environment information. For example, the prediction information generation unit 13 acquires the position of the recognized object included in the object prediction vector Va that is object recognition information generated by the object recognition unit 12, and generates the feature vector Vb that is a feature value of the distance data that is point cloud data at the position of the object in the frame F and uses it as environment information. In the example illustrated in FIG. 2, the prediction information generation unit 13 generates the feature vector Vb that is a feature value of distance data in a partial frame f shown by a white rectangle specified by the position, size, and posture of the object recognized in the frame F.

At this time, the prediction information generation unit 13 inputs, to a feature extraction model Mb having performed machine learning in advance, the distance data that is point cloud data consisting of a partial frame f, and acquires the feature vector Vb that is a feature value output from the feature extraction model Mb, to thereby generate environment information for each of the frames F. Note that the feature extraction model Mb is generated by machine-learning distance data that is point cloud data consisting of a prepared partial frame. However, the prediction information generation unit 13 is not limited to generate a feature value from the partial frame f by using the feature extraction model Mb. The prediction information generation unit 13 may generate a feature value by a method such as performing arithmetic processing for feature extraction prepared in advance by using distance data in the partial frame.

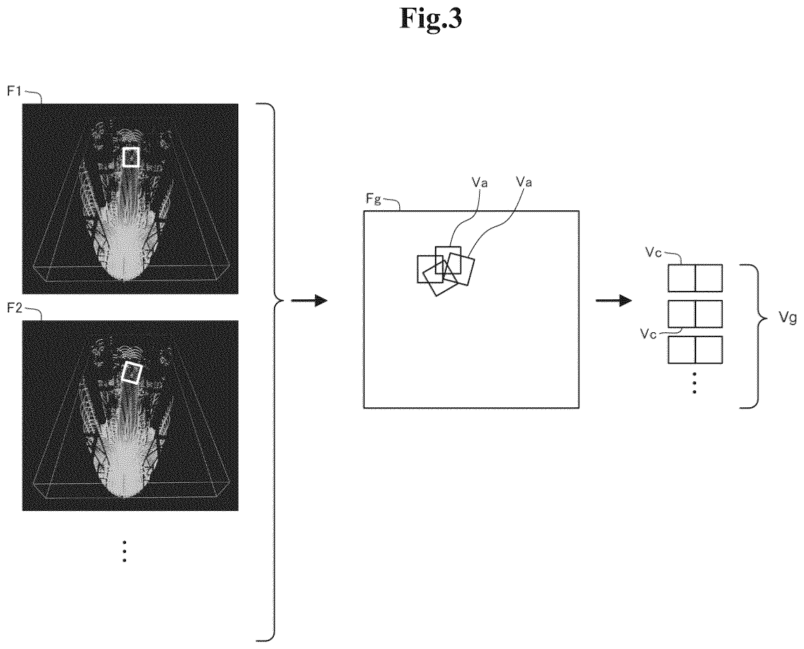

Then, as illustrated in FIG. 2, the prediction information generation unit 13 combines the feature vector Vb that is environment information generated as described above and the object prediction vector Va generated by the object recognition unit 12 to generate a prediction profile Vc that is vector information. At this time, the prediction information generation unit 13 generates the prediction profile Vc for each of the frames F. Therefore, as illustrated in FIG. 2, a plurality of prediction profiles Vc corresponding to the respective frames F are generated, so that a prediction profile group Vg is generated. That is, as illustrated in FIG. 3, first, by the object recognition unit 12, the object prediction vector Va in which the position of a rectangle and the like are specified for each of the frames of the frame group Fg consisting of a plurality of frames F1, F2, and the like, is generated and, by the prediction information generation unit 13, the feature vector Vb generated for each of the frames is added to each object prediction vector Va, and then the prediction profile group Vg configured of the respective prediction profiles Vc is generated.

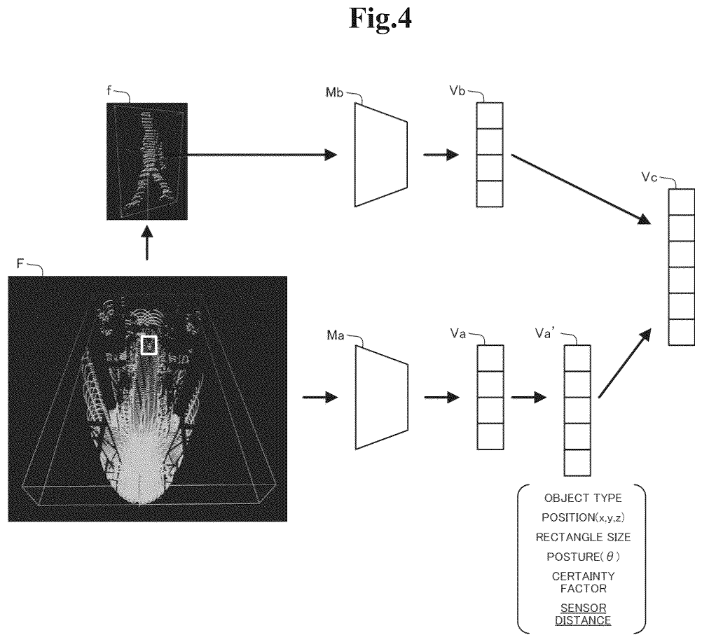

Here, besides the feature vector Vb described above, the prediction information generation unit 13 may generate the prediction profile Vc by adding another environment information representing the situation at the time of measuring the measured space, to the object prediction vector Va. Specifically, in the present embodiment, the prediction information generation unit 13 acquires the position of the recognized object included in the object prediction vector Va that is object recognition information generated by the object recognition unit 12, and uses, as environment information, the distance of the sensor (three-dimensional LiDAR) having measured the measurement data with respect to the position of the object in the frame F. Then, as illustrated in FIG. 4, the prediction information generation unit 13 generates a new object prediction vector Va′ by adding the distance of the sensor that is environment information to the object prediction vector Va, and adds the feature vector Vb to the object prediction vector Va′, to thereby generate the prediction profile Vc.

As described above, the prediction information generation unit 13 may generate the prediction profile Vc by adding the feature vector Vb and the sensor distance as environment information, to the object prediction vector Va. However, the prediction information generation unit 13 may use only the sensor distance as environment information to be added to the object prediction vector Va, or may use only the feature vector Vb. In addition, the prediction information generation unit 13 may acquire another information representing the condition of the sensor and add it to the object prediction vector Va as environment information, without being limited to the sensor distance. For example, the prediction information generation unit 13 may add information representing the surrounding environment of the location where the three-dimensional LiDAR that is a sensor is installed, in particular, information representing the environment that affects operation of the sensor (for example, temperature, weather, presence/absence of laser reflection object, and the like), to the object prediction vector Va as the environment information.

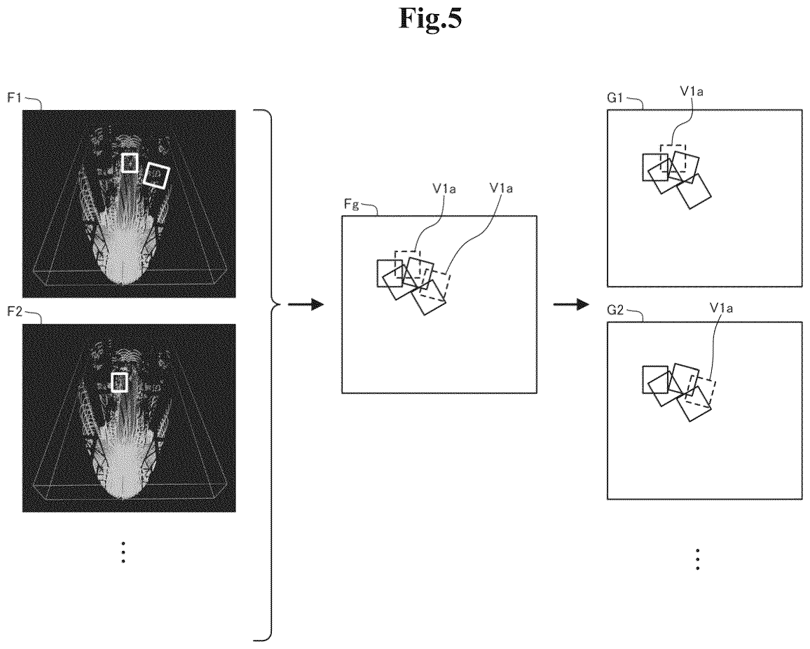

Here, the prediction information generation unit 13 generates the prediction profile group Vg consisting of the prediction profiles Vc, on the basis of the position of the object specified from the object prediction vector Va included in each prediction profile Vc. For example, the prediction information generation unit 13 includes those in which the position of the object specified by the object prediction vector Va included in the prediction profile Vc overlaps, that is, those in which rectangles corresponding to the position, size, and posture of the object that is a recognition result represented by the object prediction vector Va included in the prediction profile Vc overlaps, in the same prediction profile group Vg. At this time, however, the prediction information generation unit 13 is configured to generate the prediction profile group Vg such that at most one prediction profile Vc generated from the same frame F is included in one prediction profile group Vg. In other words, when the model generation unit 14 generates a plurality of prediction profiles Vc from the same frame F, the model generation unit 14 generates the prediction profile group Vg such that the plurality of prediction profiles Vc are not included in the same prediction profile group Vg. As an example, as illustrated in FIG. 5, it is assumed that two rectangular object prediction vectors V1a that are prediction results of object positions indicated by dotted lines from one frame F1 included in the frame group Fg. In this case, as illustrated in FIG. 5, the prediction profile group Vg is generated such that the two rectangle object prediction vectors V1a belong to different groups G1 and G2 respectively, that is, only one of the prediction profiles generated from the respective object prediction vectors V1a is included in each of the prediction profile groups G1 and G2.

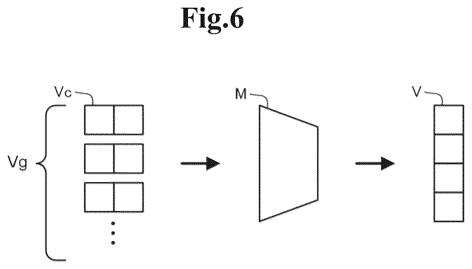

As illustrated in FIG. 6, the model generation unit 14 generates a prediction model M that inputs therein the prediction profile group Vg consisting of a set of the prediction profiles Vc generated for the frames F respectively, and outputs a prediction result vector V representing the prediction result of object recognition in the space predicted from the prediction profile group Vg. Specifically, the model generation unit 14 generates the prediction model M by setting a loss corresponding to the difference between the prediction result vector V output from the prediction model M with input of the prediction profile group Vg, and correct data corresponding to the frame group Fg constituting the learning data serving as the generation source of the prediction profile group Vg, and machine-learning and adjusting the parameter of the prediction model M in which the loss becomes minimum.

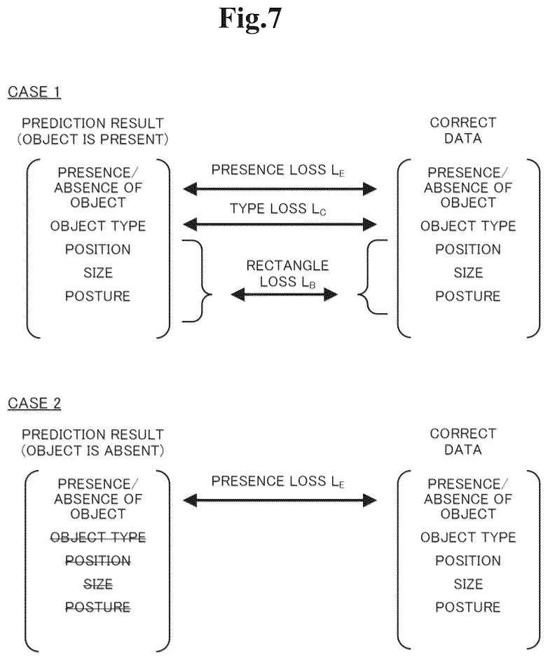

Here, a loss L to be used in the machine learning by the model generation unit 14 will be described with reference to FIG. 7. First, the prediction model M that is machine-learned by the model generation unit 14 is configured to output the prediction result vector V including information about presence/absence of an object, the type of the object, the position of the object, the size of the object, and the posture of the object as a prediction result of object recognition, as illustrated in Case 1 of FIG. 7. Then, as a loss corresponding to the difference between the prediction result and the correct data, the model generation unit 14 calculates a loss for each type of information included in the prediction result and the correct data. Specifically, as illustrated in Case 1 of FIG. 7, the model generation unit 14 calculates a presence loss L_{E} that is a loss corresponding to the difference in presence/absence of an object, an object type loss L_{C} that is a loss corresponding to the difference in the type of the object, and a rectangle loss L_{B} that is a loss corresponding to the difference in the position, size, and posture of the object. Here, as an example, the presence loss L_{E} is cross-entropy loss of presence/absence of an object, the object type loss L_{C} is cross-entropy loss of the type of the object, and the rectangle loss L_{B} is Smooth L1 loss of the rectangle position, size, and posture information.

Then, the model generation unit 14 calculates the loss L to be used for machine learning on the basis of the three types of losses described above, as expressed by Expression 1 provided below.

$$L = \{ \begin{matrix}α {L}_{E} + β {L}_{C} + γ {L}_{B} & if obj = 1 \\ α {L}_{E} & if obj = 0\end{matrix} \qquad [ Expression 1 ]$$

As expressed by Expression 1, when the prediction result by the prediction model M includes information of “object is present (obj=1)”, the model generation unit 14 calculates the loss L by combining all of the three types of losses L_{E}, L_{C}, and L_{B} as shown in Case 1 of FIG. 7. On the other hand, when the prediction result by the prediction model M includes information of “object is absent (obj=0)”, the model generation unit 14 calculates the loss L only consisting of the object presence/absence loss L_{E} among the three types of losses, as shown in Case 2 of FIG. 7.

The model generation unit 14 stores the prediction model M generated as described above. As a result, by inputting measurement data consisting of a plurality of frames F obtained by measuring a space where the object recognition result is unknown to the prediction model M, it is possible to obtain an output of the prediction result vector V that is a result of object recognition, and to perform object recognition. At that time, with respect to the prediction model M, the object prediction vector Va is generated from each of the plurality of frames F, a plurality of prediction profiles Vc are generated by applying environment information such as the feature vector Vb, and the group Vg thereof is input, as described above.

### [Operation]

Next, operation of the model generation device 10 will be descried. Note that it is assumed that the learning data described above has been stored in the model generation device 10.

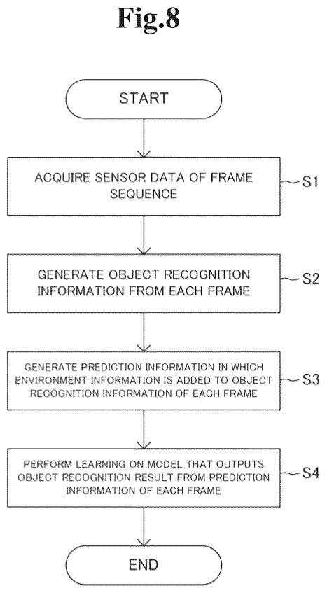

The model generation device 10 acquires measurement data consisting of a plurality of frames F obtained by measuring the same location from the learning data (step S1 in FIG. 8). For example, the model generation device 10 acquires measurement data consisting of ten frames obtained by measuring the same location one second.

Then, the model generation device 10 performs processing to recognize an object from the plurality of frames F, and generates object recognition information (step S2 in FIG. 8). At this time, the model generation device 10 generates object recognition information representing the result of recognizing an object for each frame F. For example, the model generation device inputs, to the object recognition model Ma, distance data that is point cloud data consisting of each frame F, and acquires the object prediction vector Va output from the object recognition model Ma, to thereby generate object recognition information for each of the frames F.

Then, the model generation device 10 generates a prediction profile (prediction information) in which environment information representing the situation at the time of measuring the measured space is added to the generated object recognition information (step S3 in FIG. 8). At this time, the model generation device 10 generates a prediction profile for each frame F. Specifically, the model generation device 10 generates, from distance data that is point cloud data consisting of the frame F, the feature vector Vb configured of a feature value of the distance data corresponding to the position of the recognized object, as environment information. Then, the model generation device 10 generates the prediction profile Vc that is vector information in which the object prediction vector Va and the feature vector Vg that is environment information are combined. Note that the model generation device 10 may generate the prediction profile Vc by using the distance of a sensor that measured the measurement data with respect to the position of the object in the frame F as environment information, and adding the distance of the sensor to the object prediction vector Va.

In this way, since the model generation device 10 generates the prediction profile Vc from each of the frames F by the model generation device 10, the prediction profile group Vg consisting of a plurality of prediction profiles Vc is generated. At this time, the model generation device 10 generates the prediction profile group Vg on the basis of the position of the object specified from the object prediction vector Va included in each prediction profile Vc generated from each of the frames F. For example, the model generation device 10 puts the prediction profiles Vc in which the positions of the object recognized from the respective frames F overlap each other into the same group. On the other hand, when a plurality of objects are recognized from the same frame F, the prediction profiles Vc corresponding to the plurality of objects are prevented from belonging to the same group.

Then, the model generation device 10 generates the prediction model M that inputs thereto the prediction profile group Vg and outputs the prediction result vector V representing the prediction result of object recognition in the space predicted from the prediction profile group Vg (step S4 in FIG. 8). Specifically, the model generation device 10 generates the prediction model M by setting a loss L corresponding to the difference between the prediction result vector V that is a prediction result output from the prediction model M with input of the prediction profile group Vg, and correct data corresponding to the frame group Fg constituting the learning data serving as the generation source of the prediction profile group Vg, and machine-learning the parameter of the prediction model M in which the loss becomes minimum and adjusting it.

As an example, as illustrated in Case 1 of FIG. 7, the model generation device 10 calculates the presence loss L_{E} that corresponds to the difference in presence/absence of an object, the object type loss L_{C} that corresponds to the difference in the type of the object, and the rectangle loss L_{B} that corresponds to the difference in the position, size, and posture of the object. Then, when the prediction result by the prediction model M includes information of “object is present (obj=1)”, the model generation device 10 calculates the loss L by integrating all of the three types of losses L_{E}, L_{C}, and L_{B}. On the other hand, when the prediction result by the prediction model M includes information of “object is absent (obj=0)”, the model generation device 10 calculates the loss L only consisting of the object presence/absence loss L_{E} among the three types of information as illustrated in Case 2 of FIG. 7.

As described above, in the present embodiment, a prediction model is generated by performing machine learning by using, as an input, a prediction profile in which environment information representing the situation at the measurement time is added to the plurality of pieces of measurement data. As a result, it is possible to improve the accuracy of object recognition from the measurement data using the generated prediction model.

### Second Example Embodiment

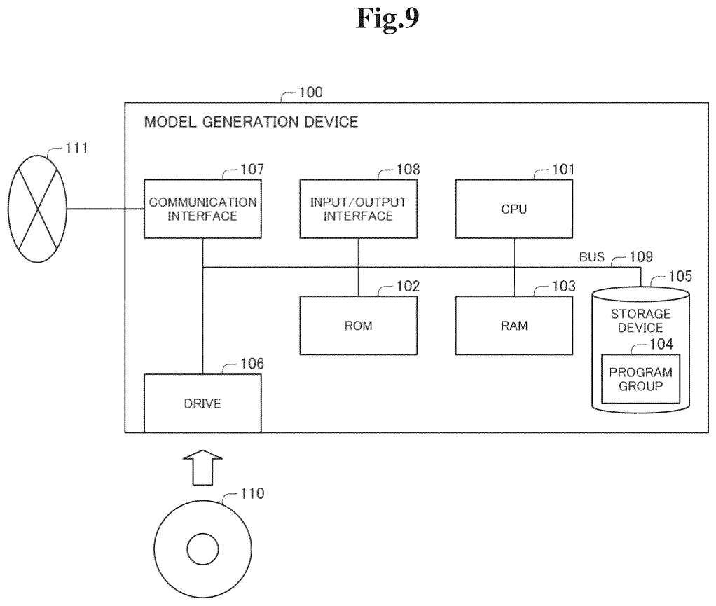

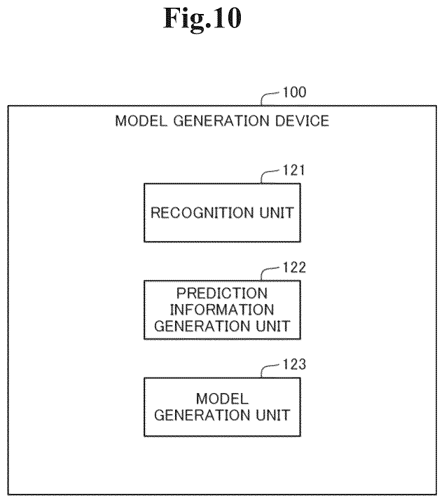

Next, a second example embodiment of the present disclosure will be described with reference to the drawings. The present embodiment shows the outline of the configuration of the model generation device explained in the embodiment described above. FIGS. 9 and 10 are diagrams for explaining the configuration, which may be related to any embodiments.

First, a hardware configuration of a model generation device 100 will be described with reference to FIG. 9. The model generation device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

FIG. 9 illustrates an example of the hardware configuration of an information processing device that is the model generation device 100. The hardware configuration of the information processing device is not limited to that described above. For example, the information processing device may be configured of part of the configuration described above, such as without the drive 106. Moreover, instead of the CPU, the information processing device may use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof.

The model generation device 100 can construct, and can be equipped with, a recognition unit 121, a prediction information generation unit 122, and a model generation unit 123 illustrated in FIG. 10 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the recognition unit 121, the prediction information generation unit 122, and the model generation unit 123 may be constructed by dedicated electronic circuits for implementing such means.

The recognition unit 121 generates, from measurement data including a plurality of frames obtained by measuring a space by a sensor, object recognition information representing information of an object recognized for each of the frames. The prediction information generation unit 122 generates, for each of the frames, prediction information in which situation information representing the situation at the time of measuring the space is added to the object recognition information. The model generation unit 123 generates a model that inputs thereto a plurality of units of the prediction information corresponding to the plurality of frames and outputs an object recognition result in the space, by machine learning using the input units of prediction information, the output object recognition result, and correct data of the object recognition result.

Since the present disclosure is configured as described above, a prediction model is generated by machine learning using, as an input, a prediction profile in which environment information representing the situation at the measurement time is added to the measurement data including a plurality of frames. As a result, it is possible to improve the accuracy of object recognition from the measurement data using the generated prediction model.

Note that at least one of the functions of the recognition unit 121, the prediction information generation unit 122, and the model generation unit 123 described above may be carried out by an information processing device provided and connected to any location on the network, that is, may be carried out by so-called cloud computing.

The program described above can be stored in a non-transitory computer-readable medium of any type and supplied to a computer. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present disclosure has been described with reference to the example embodiments described above, the present disclosure is not limited to the above-described embodiments. The form and details of the present disclosure can be changed within the scope of the present disclosure in various manners that can be understood by those skilled in the art. Moreover, the example embodiments may be combined with other example embodiments as appropriate.

### SUPPLEMENTARY NOTES

The whole or part of the example embodiments disclosed above can be described as the following supplementary notes. Hereinafter, outlines of the configurations of a model generation device, a model generation method, and a program, according to the present disclosure, will be described. However, the present disclosure is not limited to the configurations described below.

### Supplementary Note 1

A model generation device comprising:
a recognition unit that generates, from measurement data including a plurality of frames obtained by measuring a space by a sensor, object recognition information representing information of an object recognized for each of the frames;
a prediction information generation unit that generates, for each of the frames, prediction information in which situation information representing a situation at a time of measuring the space is added to the object recognition information; and
a model generation unit that generates a model that inputs, to the model, a plurality of units of the prediction information corresponding to the plurality of frames and outputs an object recognition result in the space, by machine learning using the input units of prediction information, the output object recognition result, and correct data of the object recognition result.

### Supplementary Note 2

The model generation device according to supplementary note 1, wherein
for each of the frames, the prediction information generation unit generates information based on the measurement data as the situation information, and generates the prediction information in which the situation information is added to the object recognition information.

### Supplementary Note 3

The model generation device according to supplementary note 2, wherein
for each of the frames, the recognition unit generates the object recognition information including a position of the recognized object, and
for each of the frames, the prediction information generation unit generates a feature value of the measurement data at the position of the recognized object as the situation information, and generates the prediction information in which the situation information is added to the object recognition information.

### Supplementary Note 4

The model generation device according to supplementary note 1, wherein
for each of the frames, the prediction information generation unit uses information representing a condition of the sensor in the space as the situation information, and generates the prediction information in which the situation information is added to the object recognition information.

### Supplementary Note 5

The model generation device according to supplementary note 4, wherein
for each of the frames, the recognition unit generates the object recognition information including a position of the recognized object, and
for each of the frames, the prediction information generation unit uses a distance of the sensor with respect to the position of the recognized object as the situation information, and generates the prediction information in which the situation information is added to the object recognition information.

### Supplementary Note 6

The model generation device according to supplementary note 1, wherein
for each of the frames, the recognition unit generates the object recognition information including a position of the recognized object, and
the model generation unit performs machine learning on the model by using a loss corresponding to a difference between the object recognition result output from the model and the correct data of the object recognition result, the object recognition result including at least information about whether or not the object is present and information representing the position of the object.

### Supplementary Note 7

The model generation device according to supplementary note 6, wherein
when the object recognition result output from the model includes information indicating that the object is absent, the model generation unit performs machine learning on the model by using a loss corresponding to a difference between the object recognition result including only the information about whether or not the object is present and the correct data of the object recognition result.

### Supplementary Note 8

The model generation device according to supplementary note 1, wherein
for each of the frames, the recognition unit generates the object recognition information including a position of the recognized object,
the prediction information generation unit generates a group of the prediction information generated from the object recognition information on a basis of the position of the recognized object, and
the model generation unit performs machine learning by using the prediction information belonging to a same one of the groups as an input to the model.

### Supplementary Note 8-1

The model generation device according to supplementary note 8, wherein
the prediction information generation unit generates the group such that the prediction information generated from at most one unit of the object recognition information recognized from the one of the frames is included in one of the groups.

### Supplementary Note 9

A model generation method comprising:
generating, from measurement data including a plurality of frames obtained by measuring a space by a sensor, object recognition information representing information of an object recognized for each of the frames;
for each of the frames, generating prediction information in which situation information representing a situation at a time of measuring the space is added to the object recognition information; and
generating a model that inputs, to the model, a plurality of units of the prediction information corresponding to the plurality of frames and outputs an object recognition result in the space, by machine learning using the input units of prediction information, the output object recognition result, and correct data of the object recognition result.

### Supplementary Note 9-1

The model generation device according to supplementary note 9, further comprising,
for each of the frames, generating information based on the measurement data as the situation information, and generating the prediction information in which the situation information is added to the object recognition information.

### Supplementary Note 9-2

The model generation method according to supplementary note 9-1, further comprising:
for each of the frames, generating the object recognition information including a position of the recognized object; and
for each of the frames, generating a feature value of the measurement data at the position of the recognized object as the situation information, and generating the prediction information in which the situation information is added to the object recognition information.

### Supplementary Note 9-3

The model generation method according to supplementary note 9, further comprising,
for each of the frames, using information representing a condition of the sensor in the space as the situation information, and generating the prediction information in which the situation information is added to the object recognition information.

### Supplementary Note 9-4

The model generation method according to supplementary note 9-3, further comprising:
for each of the frames, generating the object recognition information including a position of the recognized object; and
for each of the frames, using a distance of the sensor with respect to the position of the recognized object as the situation information, and generating the prediction information in which the situation information is added to the object recognition information.

### Supplementary Note 9-5

The model generation method according to supplementary note 9, further comprising:
for each of the frames, generating the object recognition information including a position of the recognized object; and
performing machine learning on the model by using a loss corresponding to a difference between the object recognition result output from the model and the correct data of the object recognition result, the object recognition result including at least information about whether or not the object is present and information representing the position of the object.

### Supplementary Note 9-6

The model generation method according to supplementary note 9-5, further comprising,
when the object recognition result output from the model includes information indicating that the object is absent, performing machine learning on the model by using a loss corresponding to a difference between the object recognition result including only the information about whether or not the object is present and the correct data of the object recognition result.

### Supplementary Note 9-7

The model generation method according to supplementary note 9, further comprising:
for each of the frames, generating the object recognition information including a position of the recognized object;
generating a group of the prediction information generated from the object recognition information on a basis of the position of the recognized object; and
performing machine learning by using the prediction information belonging to a same one of the groups as an input to the model.

### Supplementary Note 9-8

The model generation method according to supplementary note 9-7, further comprising
generating the group such that the prediction information generated from at most one unit of the object recognition information recognized from the one of the frames is included in one of the groups.

### Supplementary Note 10

A program for causing a computer to execute processing to:
generate, from measurement data including a plurality of frames obtained by measuring a space by a sensor, object recognition information representing information of an object recognized for each of the frames;
for each of the frames, generate prediction information in which situation information representing a situation at a time of measuring the space is added to the object recognition information; and
generate a model that inputs, to the model, a plurality of units of the prediction information corresponding to the plurality of frames and outputs an object recognition result in the space, by machine learning using the input units of prediction information, the output object recognition result, and correct data of the object recognition result.

### REFERENCE SIGNS LIST

10 model generation device
11 frame sequence generation unit
12 object recognition unit
13 prediction information generation unit
14 model generation unit
16 learning data storage unit
100 model generation device
101 CPU
102 ROM
103 RAM
104 program group
105 storage device
106 drive
107 communication interface
108 input/output interface
109 bus
110 storage medium
111 communication network
121 recognition unit
122 prediction information generation unit
123 model generation unit

1. A model generation device comprising:
at least one memory configured to store instructions; and
at least one processor configured to execute instructions to:
generate, from measurement data including a plurality of frames obtained by measuring a space by a sensor, object recognition information representing information of an object recognized for each of the frames;
for each of the frames, generate prediction information in which situation information representing a situation at a time of measuring the space is added to the object recognition information; and
generate a model that inputs, to the model, a plurality of units of the prediction information corresponding to the plurality of frames and outputs an object recognition result in the space, by machine learning using the input units of prediction information, the output object recognition result, and correct data of the object recognition result.

2. The model generation device according to claim 1, wherein the at least one processor is configured to execute the instructions to,
for each of the frames, generate information based on the measurement data as the situation information, and generate the prediction information in which the situation information is added to the object recognition information.

3. The model generation device according to claim 2, wherein the at least one processor is configured to execute the instructions to:
for each of the frames, generate the object recognition information including a position of the recognized object; and
for each of the frames, generate a feature value of the measurement data at the position of the recognized object as the situation information, and generate the prediction information in which the situation information is added to the object recognition information.

4. The model generation device according to claim 1, wherein the at least one processor is configured to execute the instructions to,
for each of the frames, use information representing a condition of the sensor in the space as the situation information, and generate the prediction information in which the situation information is added to the object recognition information.

5. The model generation device according to claim 4, wherein the at least one processor is configured to execute the instructions to:
for each of the frames, generate the object recognition information including a position of the recognized object; and
for each of the frames, use a distance of the sensor with respect to the position of the recognized object as the situation information, and generate the prediction information in which the situation information is added to the object recognition information.

6. The model generation device according to claim 1, wherein the at least one processor is configured to execute the instructions to:
for each of the frames, generate the object recognition information including a position of the recognized object; and
perform machine learning on the model by using a loss corresponding to a difference between the object recognition result output from the model and the correct data of the object recognition result, the object recognition result including at least information about whether or not the object is present and information representing the position of the object.

7. The model generation device according to claim 6, wherein the at least one processor is configured to execute the instructions to,
when the object recognition result output from the model includes information indicating that the object is absent, perform machine learning on the model by using a loss corresponding to a difference between the object recognition result including only the information about whether or not the object is present and the correct data of the object recognition result.

8. The model generation device according to claim 1, wherein the at least one processor is configured to execute the instructions to:
for each of the frames, generate the object recognition information including a position of the recognized object;
generate a group of the prediction information generated from the object recognition information on a basis of the position of the recognized object; and
perform machine learning by using the prediction information belonging to a same one of the groups as an input to the model.

9. A model generation method comprising:
generating, from measurement data including a plurality of frames obtained by measuring a space by a sensor, object recognition information representing information of an object recognized for each of the frames;
for each of the frames, generating prediction information in which situation information representing a situation at a time of measuring the space is added to the object recognition information; and
generating a model that inputs, to the model, a plurality of units of the prediction information corresponding to the plurality of frames and outputs an object recognition result in the space, by machine learning using the input units of prediction information, the output object recognition result, and correct data of the object recognition result.

10. A non-transitory computer-readable medium storing thereon a program comprising instructions for causing a computer to execute processing to:
generate, from measurement data including a plurality of frames obtained by measuring a space by a sensor, object recognition information representing information of an object recognized for each of the frames;
for each of the frames, generate prediction information in which situation information representing a situation at a time of measuring the space is added to the object recognition information; and
generate a model that inputs, to the model, a plurality of units of the prediction information corresponding to the plurality of frames and outputs an object recognition result in the space, by machine learning using the input units of prediction information, the output object recognition result, and correct data of the object recognition result.
